(19) United States
(12) Patent Application Publication
(10) Pub. No.: US 2025/0116596 A1
(43) Pub. Date: Apr. 10, 2025

(54) FOOD ASSESSMENT DEVICE AND METHOD THEREOF

(71) Applicant: HCL Technologies Limited, New Delhi (IN)

(72) Inventors: GURGENIUS SINGH KAPOOR, Bangalore (IN); SHATAKSHII SHUKLA, Bangalore (IN); VINAYAK KUMAR, Bangalore (IN); KANISHK SINGH, Bangalore (IN)

(21) Appl. No.: 18/440,992

(22) Filed: Feb. 14, 2024

(30) Foreign Application Priority Data
Oct. 9, 2023 (IN) 202311067625

(51) Int. Cl. G01N 21/01; G01B 11/28; G01G 19/413; G01N 21/3563; G01N 21/95

(52) U.S. Cl. CPC G01N 21/01; G01B 11/285; G01G 19/413; G01N 21/3563; G01N 21/95; G01N 2021/0187; G01N 2223/618

(57) ABSTRACT

This invention relates to a food assessment device. The food assessment device includes a turntable plate for accommodating a food item. The food assessment device further includes a lid enclosing the turntable plate. Further, surface of the lid includes at least one Artificial Intelligence (AI) enabled camera to capture one of video data, or image data of the food item for identifying the food item, a set of Near Infrared (NIRED) sensors for determining chemical composition of the food item, at least one Light Detecting and Ranging (LIDAR) sensor for determining volume of the food item. It should be noted that each of the at least one AI enabled camera, the set of NIRED sensors, and the at least one LIDAR sensor faces towards the food item and scans the food item until the turntable plate completes a rotation.

### TECHNICAL FIELD

This disclosure generally relates to nutrition measurement systems, particularly the disclosure relates to a food assessment device and a method of food assessment using the food assessment device.

### BACKGROUND

Multiple purposes are served by monitoring one's food intake, ranging from broader aspects of maintaining public health and enhancing overall fitness to more specific situations including management of certain medical conditions. Further, various diseases require adherence to specialized diets aimed at either mitigating symptoms or facilitating their elimination. Such dietary plans often involve restriction of particular nutrients-for example, limiting carbohydrates for individuals facing diabetes, reducing protein intake for those dealing with liver disorders, or reducing sodium consumption for individuals facing hypertension.

Additionally, many people aim to manage their calorie and nutrient intake, paying close attention to things like unhealthy fats. The people do this to prevent issues like obesity and heart diseases. This effort is especially important considering ongoing health challenges in today's society. Thus, an act of monitoring what one consumes resonates as a multifaceted tool, harmonizing general health maintenance, disease management, athletic preparation, and medication effectiveness. Various systems exist for tracking food intake. The existing systems require weighing scales, measuring cups, and mobile apps, which can be cumbersome and imprecise. This complexity may delay progress toward fitness goals which require proper meal intake with proper nutrients and macronutrients on a daily basis. The existing systems are complex, costly, inconvenient, and lack in real-time monitoring, and provide erroreous results.

The present invention is directed to overcome one or more limitations stated above or any other limitations associated with the known arts.

### SUMMARY

In one embodiment, a food assessment device is disclosed. The food assessment device may include a turntable plate for accommodating at least one food item. It should be noted that the turntable plate may be rotational. The food assessment device may further include a lid enclosing the turntable plate. Surface of the lid may include at least one Artificial Intelligence (AI) enabled camera to capture at least one of video data, or image data of the at least one food item for identifying the at least one food item. The surface of the lid may further include a set of Near Infrared (NIRED) sensors for determining chemical composition of the at least one food item. The surface of the lid may further include at least one Light Detecting and Ranging (LIDAR) sensor for determining volume of the at least one food item. It should be noted that each of the at least one AI enable camera, the set of NIRED sensors, and the at least one LIDAR sensor faces towards the at least one food item and scans the at least one food item until the turntable plate completes a rotation.

In another embodiment, a method of food assessment using a food assessment device is disclosed. In one example, the method may include receiving a user input for assessing at least one food item placed on a turntable plate of the food assessment device, from a user. It should be noted that the turntable plate may be rotational and enclosed with a lid. The lid may further include at least one Artificial Intelligence (AI) enabled camera, a set of Near Infrared (NIRED) sensors, and at least one Light Detection and Ranging (LIDAR) sensor facing towards the at least one food item. The method may further include, in response to the user input, starting a rotation of the turntable plate accommodating the at least one food item in a predefined direction. It should be noted that the turntable plate may rotate for a predefined time. The method may further include, in response to the user input, scanning the at least one food item until the turntable plate completes the rotation. The scanning of at least one food item may include capturing at least one of video data, or image data of the at least one food item to identify the at least one food item, through the at least one AI enabled camera. The scanning of the at least one food item may further include determining a chemical composition of the at least one food item by the set of NIRED sensors. The scanning of the at least one food item may further include determining volume of the at least one food item by the at least one LIDAR sensor.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary food assessment device, in accordance with some embodiments of the present disclosure.

FIG. 2 illustrates an exemplary process of a method of food assessment using a food assessment device, in accordance with some embodiments of the present disclosure.

FIG. 3 illustrates an exemplary scenario of communication between a food assessment device and an application running on a user device, in accordance with some embodiments of the present disclosure.

FIGS. 4A-4F illustrate an exemplary workflow of a food assessment device, in accordance with some embodiments of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

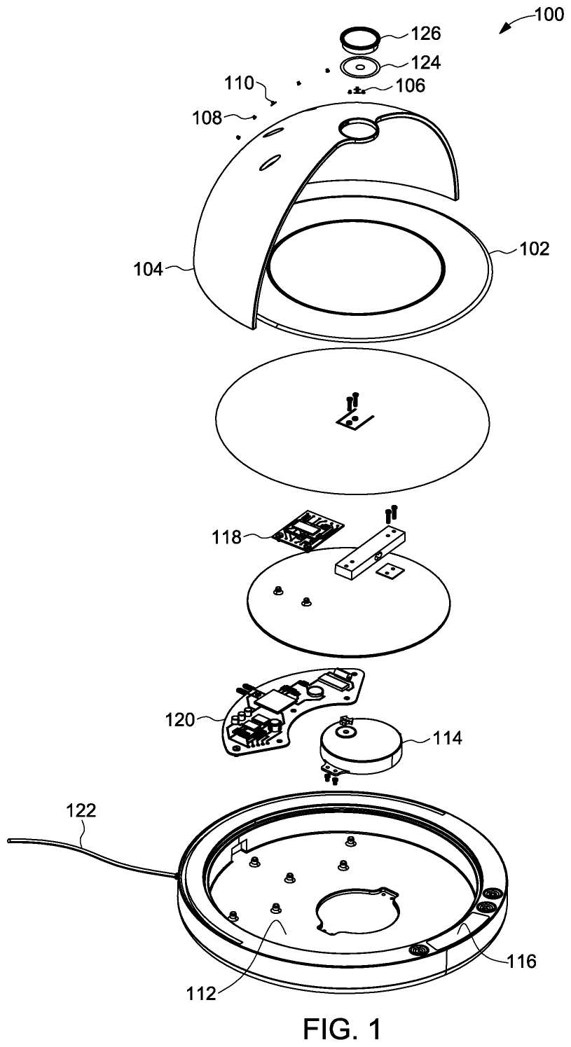

Referring now to FIG. 1, an exemplary food assessment device 100 is illustrated, in accordance with some embodiments of the present disclosure. The food assessment device 100 may evaluate and analyze various aspects of food items. The food assessment device 100 uses sensors, cameras, and algorithms to provide information about nutritional content (for example, macronutrients), quality (freshness and ripeness of food), safety, and even authenticity of the food items being assessed. The food assessment device 100 may offer users accurate and valuable information through a User Interface (UI), to make informed decisions about their dietary choices.

The food assessment device 100 may include a turntable plate 102 for accommodating at least one food item. It should be noted that the turntable plate 102 may be rotational. The turntable plate 102 allows easy placement and removal of the at least one food item for assessment. Rotational feature of the turntable plate 102 ensures thorough scanning and the assessment of the at least one food item from all angles. The food assessment device 100 may further include a lid 104. The lid 104 may have a dome-shaped structure. The lid 104 may enclose the turntable plate 102 fully or partially, as the lid 104 may be a full coverage lid or a half coverage lid. In some embodiments, the lid 104 may be a fixed dome.

In FIG. 1, the half coverage lid—the fixed dome is illustrated. The half coverage lid covers only a portion of the turntable plate 102 or the food items placed on the turntable plate 102. In some embodiments, the half coverage lid may be used for certain assessments which require partial exposure, or where ease of use and quick access to the food items are priorities. The disclosure is not limited to the half coverage lid, there may be the full coverage lid instead of the half coverage lid. The full coverage lid may completely enclose the turntable plate 102 and the food items placed on it. The full coverage lid may offer a comprehensive and controlled environment for accurate food assessment.

As illustrated in FIG. 1, surface of the lid 104 may include at least one Artificial Intelligence (AI) enabled camera 106, a set of Near Infrared (NIRED) sensors 108, and at least one Light Detection and Ranging (LIDAR) sensor 110, which may be present at inner surface of the lid 104.

The at least one AI-enabled camera 106 may be configured to capture at least one of video data, or image data of the at least one food item for identifying the at least one food item. The AI-enabled camera 106 may use artificial intelligence techniques and image processing techniques (such as Convolution Neural Network (CNN) models, YOLO, transfer learning, Generative Adversarial Networks (GANs), and the like) to capture visual data and potentially identify a food type. The set of NIRED sensors 108 may be configured for determining a chemical composition and water content of the at least one food item. The set of NIRED sensors 108 may collect data based on near-infrared light emissions and reflections from the at least one food item. The set of NIRED sensors 108 may provide insights into food's composition. The Near-infrared light may refer to light with wavelengths just beyond visible spectrum, typically ranging from around 700 to 2500 nanometers. This range of wavelengths is particularly useful for spectroscopy because it may penetrate certain materials, including food items, without causing significant damage or alteration. When the near-infrared light passes through or interacts with the at least one food item, the near-infrared light gets absorbed, transmitted, or scattered. Different types of molecules and materials absorb the near-infrared light at specific wavelengths, leading to unique spectral patterns. By analyzing a way that the near-infrared light is absorbed or reflected, valuable information may be gathered about the composition and properties of the at least one food item.

By way of an example, the set of NIRED sensors 108 may emit the near-infrared light towards the at least one food item and then analyze the emitted or reflected light that interacts with the at least one food item. The way the light is absorbed, transmitted, or reflected may provide insights into the food's composition. This way information about how the near-infrared light is absorbed by the various molecules present in the at least one food item may be collected. Different molecules, such as water, carbohydrates, fats, and proteins, have unique absorption patterns in the near-infrared spectrum.

The at least one LIDAR sensor 110 may be configured for determining volume of the at least one food item. The at least one LIDAR sensor 110 may emit laser pulses and measure time it takes for the light to bounce back after reflecting off the at least one food item. A time delay may be computed by determining speed of laser light, which may provide an accurate distance measurement. When the emitted laser light hits the at least one food item, some of it gets reflected to the at least one LIDAR sensor 110. By analyzing the time delay and intensity of the reflected light, the at least one LIDAR sensor 110 may create detailed maps of the at least one food item's shape and structure. Thus, the at least one LIDAR sensor 110 may gather detailed spatial information about the at least one food item.

It should be noted that each of the at least one Al-enabled camera 106, the set of NIRED sensors 108, and the at least one LIDAR sensor 110 faces towards the at least one food item placed on the turntable plate 102 and scans the at least one food item until the turntable plate 102 completes a rotation.

Further, it should be noted that the turntable plate 102 may be placed on a base section providing steadiness to the turntable plate 102. The base section may include a housing 112 for a motor 114 coupled to the turntable plate 102 for rotating the turntable plate 102 in a predefined direction for a predefined time, providing sufficient time to scan the at least one of the food item. The motor 114 may be a servo motor, a geared Direct Current (DC) motor, a Brushless DC (BLDC) motor, a stepper motor, or the like. The predefined time refers to a specific duration (for example, 1 minute, 40 seconds, and the like) for which the turntable plate 102 and the at least one food item may be rotated to complete one rotation (360 degree horizontal rotation along a vertical axis). The housing 112 may be referred to as an enclosure that holds certain components including the motor 114 of the food assessment device 100. The motor 114 may be responsible for driving rotation of the turntable plate 102. The motor 114 may be mechanically coupled to the turntable plate 102 through a coupler, which means that its movement may be transmitted to the turntable plate 102, causing the turntable plate 102 to rotate. The motor 114 may be controlled by an electrical system that determines the direction of rotation (i.e., a clockwise or a counterclockwise) and a speed at which the turntable plate 102 rotates. Rotation of the turntable plate 102 ensures that different sides of the at least one food item may be exposed to scanning process, ensuring a thorough and accurate scan.

By way of an example, consider that the turntable plate 102 may rotate at speed 10 Revolution Per Minute (RPM) in a clockwise direction. In that case, the turntable plate 102 may take 6 seconds to complete one rotation. This means the turntable plate 102 may complete one rotation in 6 seconds and at least one food item may be scanned in that 6 seconds. By way of another example, the turntable plate 102 may rotate at speed 2 RPM in a clockwise direction. In such a case, the turntable plate 102 may take 30 seconds to complete one rotation. This means the turntable plate 102 may complete one rotation in 30 seconds and at least one food item may be scanned in that 30 seconds. The speed, time, direction of rotation may be preconfigured based on requirement.

Moreover, the base section may further include a UI 116. The UI 116 may further include a display screen. This UI 116 may be configured to provide information and interaction related to the at least one item and its scanning result, to a user. In other words, the UI 116 serves as a means for users to interact with the food assessment device 100, view information, and perform certain actions related to the scanning process and its outcomes. The display screen may be configured for displaying a report associated with the at least one food item. The UI 116 may further include a set of buttons near the display screen for providing inputs for storing the report of the at least one food item and syncing display of the report on a user device. The buttons may be push-button, touch-button or press-button. Examples of the user device may include, but are not limited to, a smartphone, a laptop, a mobile phone, a smart watch, smart-band, a smart wearable, or any other computing device.

It should be noted that the report may include, but not limited to, a type of the at least one food item (for example, fruits, vegetables, protein sources, grains, dairy items, sweets, beverages, etc.) nutritional content of the at least one food item (for example, macros including carbohydrates, proteins, and fats), an amount of calories within the at least one food item (for example, one medium apple may have about 95 calories and a large egg may have about 70 calories), date and time information of the report generated for the at least one food item (i.e., when the report is generated for a specific food item). The report may be generated based on data collected by scanning the at least one food item via the at least one AI-enabled camera 106, a set of NIRED sensors 108, and the at least one (LIDAR) sensor 110. In some embodiments, a comparison of the data scanned in real-time with historical data stored in a database may be performed to determine the nutritional content and generate the report.

The UI 116 may further include a power button near the display screen to operate the food assessment device 100. The power button may be used by the user to power off or power on the food assessment device 100. In addition, the food assessment device 100 may further include at least one weight sensor 118 between the turntable plate 102 and the housing 112. The weight sensor 118 may be configured for collecting weight data of the at least one food item placed on the turntable plate 102. It should be noted that the housing 112 further includes a controller 120. The controller 120 may be configured to control functioning of each of the at least one weight sensor, the at least one AI enabled camera 106, the set of NIRED sensors 108, the at least one LIDAR sensor 110, the motor and the display screen. Further, the controller may be configured for synchronization of the report on the user device. The controller 120 may be coupled to the power button and the set of buttons.

The lid 104 may further include a lightning panel 124. The controller 120 may be coupled to the lightning panel 124. The lightning panel 124 may be configured for illuminating a cavity formed by the lid while enclosing the turntable plate 102 when receives a signal from the controller 120. This way the lightning panel 124 may illuminate the at least one food item placed on the turntable plate 102, providing effective and accurate scanning of the at least one food item. The lid 104 may also include a display screen 126 on the top of the lid for displaying a scanning percentage (for example, 10%, 20%, 30%, and the like) or a sign of scanning in process, of at least one food item. The food assessment device 100 may include a power cord 122 for power supply connection.

In some embodiments, the report or the scanned data generated by the food assessment device 100 may be stored in a cloud storage, which is a digital storage place on the internet. The cloud storage not only keeps recent data, but also historical data (collected through historical assessments) that helps the food assessment device 100 to work accurately. The users of the food assessment device 100 may be capable of accessing their own data through the corresponding user devices (that may be a phone or a computer) or an associated application platform. It should be noted that a user may be able to see data related to that user only, not other user's data. The users may be able to access the data from anywhere through the user devices.

As will be appreciated by one skilled in the art, a variety of processes may be employed for food assessment. For example, the exemplary food assessment device 100 may perform food assessment, by the process discussed herein. In particular, as will be appreciated by those of ordinary skill in the art, control logic and/or automated routines for performing the techniques and steps described herein may be implemented by the food assessment device 100 either by hardware, software, or combinations of hardware and software. For example, suitable code may be accessed and executed by the a processor in food assessment device 100 to perform some or all of the techniques described herein. Similarly, application specific integrated circuits (ASICs) configured to perform some or all the processes described herein may be included in the processor in the food assessment device.

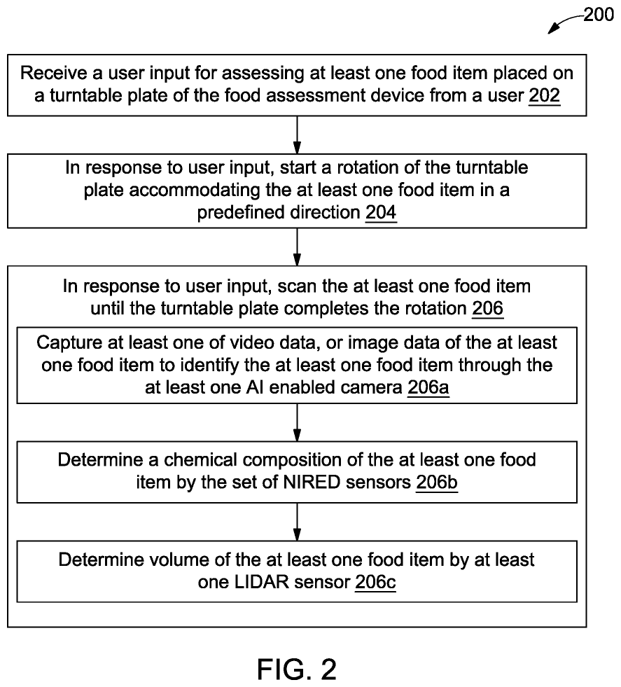

Referring now to FIG. 2, a flow diagram of an exemplary process of food assessment using a food assessment device (same as the food assessment device 100) is depicted via a flowchart 200, in accordance with some embodiments of the present disclosure. Each step of the flowchart 200 is performed using the food assessment device. FIG. 2 is explained in conjunction with FIG. 1

At step 202, a user input may be received for assessing at least one food item, from a user. The at least one food item may be placed on a turntable plate (for example, the turntable plate 102) of the food assessment device. The user input may be related to activation of the food assessment device and placement of the at least one food item on the turntable plate. It should be noted that the turntable plate may be rotational (i.e., the turntable plate covers a 360 degree rotation horizontally) and enclosed with a lid (such as the lid 104). Inner surface of the lid may include at least one Artificial Intelligence (AI) enabled camera (analogues to the at least one AI-enabled camera 106), a set of Near Infrared (NIRED) sensors (same as the set of NIRED sensors 108), and at least one Light Detecting and Ranging (LIDAR) sensor (same as the at least one LIDAR sensor 110) facing towards the at least one food item.

In response to receiving the user input, at step 204, a rotation of the turntable plate accommodating the at least one food item may be started, in a predefined direction (for example, in a clockwise or an anticlockwise direction). It should be noted that the turntable plate rotates for a predefined time. The turntable plate may be placed on a base section providing steadiness to the turntable plate. The base section includes a housing (such as the housing 112) for accommodating a motor (such as the motor 114) coupled to the turntable plate and configured for rotating the turntable plate. In some embodiments, weight data of the at least one food item may be collected via at least one weight sensor (such as the at least one weight sensor 118). The weight sensor may be placed between the turntable plate and the housing.

At step 206, in response to the user input, the at least one food item may be scanned until the turntable plate completes the rotation. The scanning of the at least one food item further includes sub-steps 206a-206c. At step 206a, at least one of video data, or image data of the at least one food item may be captured to identify the at least one food item through the at least one AI-enabled camera. At step 206b, a chemical composition and water content of the at least one food item may be determined by the set of NIRED sensors. At step 206, volume of the at least one food item may be determined by the at least one LIDAR sensor.

Further, in some embodiments, a report associated with the at least one food item may be generated based on data collected by scanning of the at least one food item via the at least one AI-enabled camera, the set of NIRED sensors, and the at least one LIDAR sensor, and the weight data. It should be noted that the report may include a type of the at least one food item, the nutritional content of the at least one food item, and a number of calories within the at least one food item, date and time information of the report generated for the at least one food item. In some embodiments, for generating the report, the data scanned in real-time may be compared with historical data stored in a database to determine the nutritional content.

Further, the base section may include a UI (such as the UI 116). The UI may be configured for displaying the report associated with the at least one food item on a display screen of the UI as well as on a display screen of a user device. In some embodiments, the UI may also display visual indicators for signal strength. The visual indicators may be represented as bars or icons (for example, Ethernet cable icons with signal bars) and their appearance may reflect the network type (i.e., Wi-Fi or wired). Further, the UI may be configured for providing inputs for storing the report of the at least one food item through a set of buttons near the display screen and syncing the display of the report on the user device. The UI may also be configured for operating the food assessment device via a power button near the display screen.

It should be noted that the housing may further include a controller configured to control functioning of each of the at least one weight sensor, the at least one AI-enabled camera, the set of NIRED sensors, the at least one LIDAR sensor, the motor and the display screen, and for synchronization of the report to the user device.

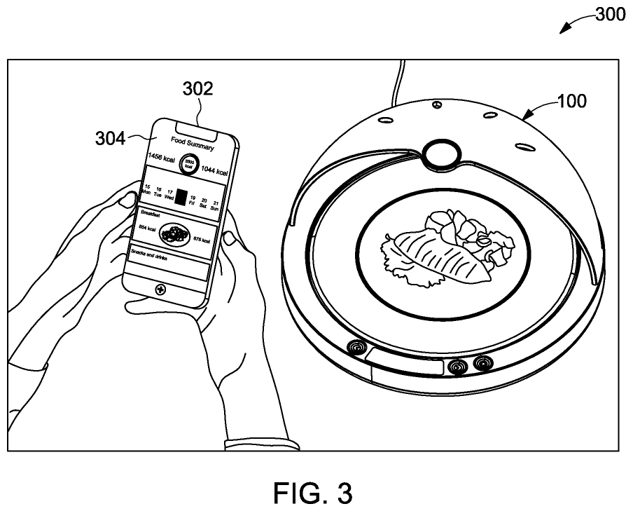

In some embodiments, a cavity formed by the lid while enclosing the turntable plate may be illuminated via a lighting panel (such as the lighting panel 124) provided the lid. In other words, the at least one food item when placed on the turntable plate may also be illuminated, providing sufficient light for scanning. It should be noted that the shape of the lid may be a dome-shaped structure, and the lid may be a fixed-dome. Further, in some embodiments, a scanned percentage of the least one food item may be displayed via a display screen (such as the display screen 126) provided on top of the lid. Further, the food assessment device may be associated with the user device (i.e., a computing device) through a wired or wireless connection that may show all the generated report, the real-time scanned percentage, and suggestions. This is discussed later in conjunction with FIG. 3.

Referring to FIG. 3, an exemplary scenario 300 of communication between a food assessment device 100 and an application running on a user device is illustrated, in accordance with some embodiments of the present disclosure. FIG. 3 is explained in conjunction with FIGS. 1-2. The user device may include, but is not limited to, mobile phones, tablets, or any computing screen. As depicted via the FIG. 3, the scenario 300 includes a smartphone 302 as the user device. The smartphone 302 and the food assessment device 100 may be operated by a user. The user may be a regular person, a healthcare professional, a manager, a supervisor, a dietician, an operator, an administrator, or the like.

The smartphone 302 may be connected to the food assessment device 100 via a network. The network, for example, may be any wired or wireless network and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS).

The application (i.e., a food assessment application) running on the smartphone 302 may provide users with a comprehensive and user-friendly experience for assessing and managing their dietary habits. In some embodiments, the application may include user authentication and profile creation. For example, the users may create accounts, log in securely, and personalize their profiles with information such as age, gender, weight, and dietary preferences.

The application may include a UI 304 through which the users may access various features and information. Thus, the users may be able to track what they eat and drink throughout the day. In some embodiments, the food assessment device 100 may be synced with the application, and subsequently the UI 304 may display the report associated with the at least one food item placed on the food assessment device 100, to the user. Generation of the report has already been explained in FIGS. 1-2. In some embodiments, the report or the scanned data may be stored in a cloud storage as historical data as well as in local storage of the food assessment device 100 that may be used for producing accurate readings. The users may be able to access their historical data or reports from the cloud storage through the user devices or the application platform. One user won't be able to access other user's data unless the user has access rights to access the other user's data. The smartphone 302 may include a memory, and the report may also be stored in the memory for further requirement. In some other embodiments, the UI 304 of the application may have multiple functionalities to control and regulate the food assessment device 100. For example, the application may control scanning of the at least one food item by sending a signal to a controller (such as the controller 120) to control the AI-enabled camera and other sensors of the food assessment device.

In one embodiment, the UI 304 may show food summary. The food summary may include calories, macronutrients (carbohydrates, proteins, fats), vitamins, minerals, and other relevant data of the at least one food item which may be placed on the food assessment device 100. The users may also be able to check past data of food items which have been placed on the turntable plate through the application. By way of an example, the users may be able to check their daily water intake to ensure they stay hydrated. The food summary displayed on the UI 304 may include weight of the at least one food item, the data generated by at least one AI-enabled camera, the set of NIRED sensors, and at least one LIDAR sensor. The UI 304 may show all the information collected and generated by the food assessment device 100. For example, in some embodiments, real-time scanning percentage of the at least one food item may also be displayed on the UI 304.

In some embodiments, the UI 304 may provide a systematic and user specific diet plan on daily basis and observe calorie intake. The UI 304 offers meal suggestions, recipes, and portion recommendations. The users may plan meals based on their dietary goals and preferences. In addition, the UI 304 may alert the users to potential allergens or ingredients that may conflict with their dietary restrictions.

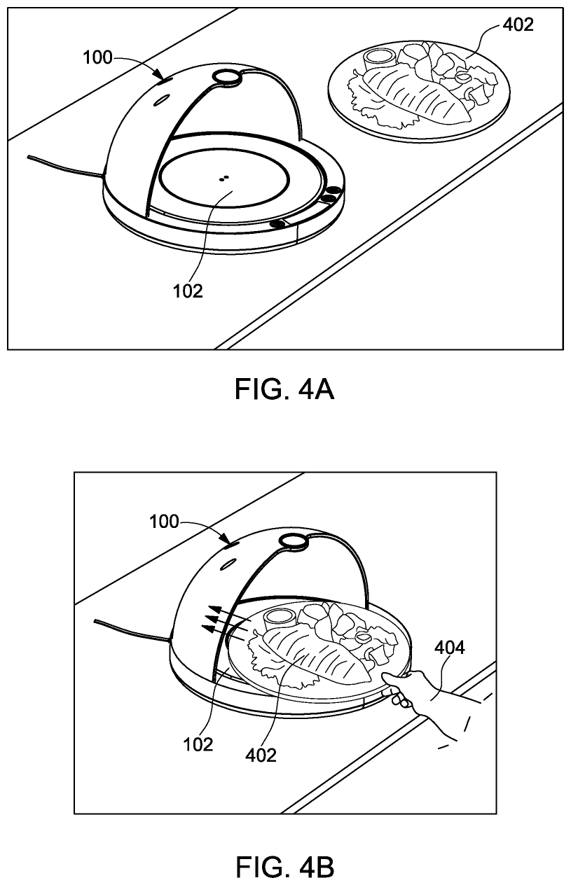

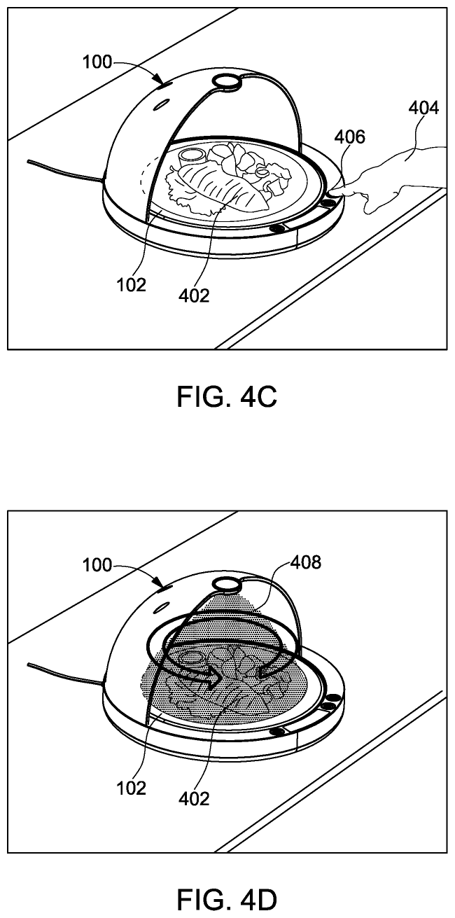

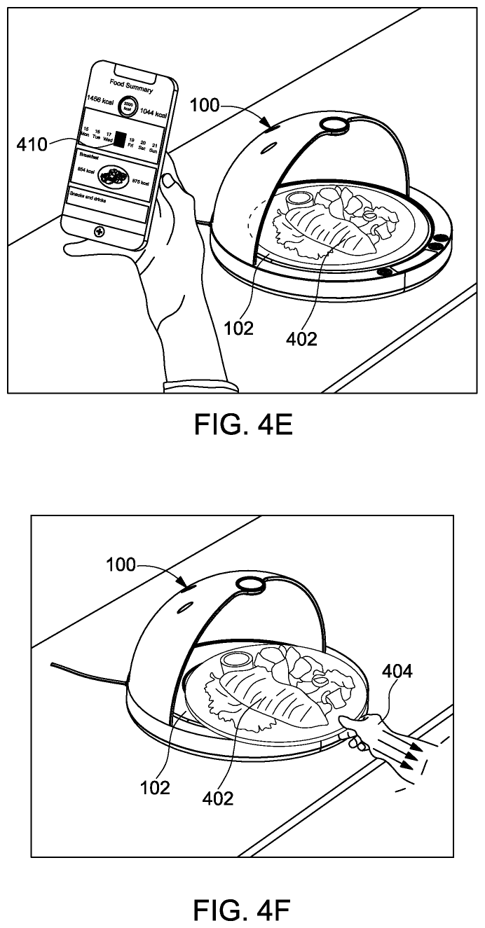

Referring now to FIGS. 4A-4F, an exemplary workflow of a food assessment device 100 is illustrated, in accordance with an exemplary embodiment of the present disclosure. FIGS. 4A-4F are explained in conjunction with FIGS. 1-3.

In FIG. 4A, the food assessment device 100 and a food item 402 in a plate are shown. The food assessment device 100 may be connected to a power source to start the operation. The food assessment device 100 may have a half coverage lid. Now, a user 404 may want to calculate nutrients (for example, macronutrients) of the food item 402. In such a case, initially, the user 404 may put the food item 402 on a turntable plate 102 of the food assessment device 100, as depicted in FIG. 4B.

Further, the user 404 may switch on a power button 406 present on a UI (such as the UI 116) of the food assessment device 100, as illustrated in FIG. 4C. Once the power button 406 is switched on, a lightning panel (such as the lighting panel 124) may start illumination to illuminate the food item 402 (as illustrated in FIG. 4D). In some embodiments, weight of the food item 402 may be recorded when placed on the turntable plate 102 through a weight sensor (such as the weight sensor 118).

Once the food item 402 is placed on the turntable plate 102, the power button 406 is pressed or switched on, and the illumination is started, the turntable plate 102 may start its rotation in a direction 408 for a predefined period of time and simultaneously scanning of the food item 402 may start, as illustrated in FIG. 4D. The scanning may continue until the turntable plate 102 completes a rotation. The scanning may be performed using an AI-enabled camera (such as the at least one AI-enabled camera 106), a LIDAR sensor (such as the at least one LIDAR sensor 110), and a set of NIRED sensors (such as the set of NIRED sensors 108).

The AI-enabled camera may capture video data of the food item 402 for identifying the food item 402. The set of NIRED sensors may determine a chemical composition and water content of the food item 402. The LIDAR sensor may determine volume of the food item 402. Based on scanning, a report including a type of the food item 402, nutritional content of the food item 402, a number of calories within the food item 402, date and time information of the report generated for the food item 402, may be generated. The report may be displayed on the display screen of the UI of the food assessment device 100.

Further, FIG. 4E shows communication of the food assessment device 100 and a user device 410 (i.e., a mobile phone). The user device 410 may be connected to the food assessment device 100 via a wired or wireless connection. The report may also be transmitted to the user device 410 through an associated computer application. The user 404 may be able to check the report through the application. The user device 410 store the report in an associated database for further use. This is already explained in detail in FIG. 3. Now, the user 404 may take the food item 402 out of the food assessment device 100, as depicted in FIG. 4F.

Thus, the present disclosure may overcome drawbacks of traditional systems discussed before. The disclosure may aid users consistent monitoring of their nutritional intake. The disclosure helps in maintaining a detailed record of nutritional information, including macronutrients, meal timings, and dates, in an associated database. This database enables the users with valuable references for their dietary patterns. The disclosure includes NIRED sensors to precisely scan the macronutrients like three essential nutrients (carbohydrates, fats, and protein) present in the food. The disclosure includes an AI-based camera to identify the food and a LIDAR sensor for accurate food volume measurement. This integration of sensors ensures accurate and comprehensive food assessment. The combined functionalities of macro scanning, food identification, and volume measurement provide a comprehensive analysis of each meal, giving the users a deeper understanding of their nutritional choices. The turntable's multi-functionality enhances user convenience by serving as both a weighing scale and a platform for scanning. This streamlined approach saves time and effort. The food assessment device 100 has an associated application. The application's user-friendly interface simplifies the tracking process. The collected data provides the users personalized insights into their dietary habits, allowing them to make necessary adjustments for improved well-being. The disclosure helps the users to quickly scan, assess, and record their meals, saving time and promoting consistency. Thus, the disclosure offers a range of benefits, from accurate and convenient tracking to personalized insights, fostering improved dietary habits and contributing to users' overall well-being.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A food assessment device comprising:
a turntable plate for accommodating at least one food item, wherein the turntable plate is rotational; and
a lid enclosing the turntable plate, wherein surface of the lid comprises:
at least one Artificial Intelligence (AI) enabled camera to capture at least one of video data, or image data of the at least one food item for identifying the at least one food item;
a set of Near Infrared (NIRED) sensors for determining chemical composition of the at least one food item; and
at least one Light Detection and Ranging (LIDAR) sensor for determining volume of the at least one food item,
wherein each of the at least one AI enabled camera, the set of NIRED sensors, and the at least one LIDAR sensor faces towards the at least one food item and scans the at least one food item until the turntable plate completes a rotation.

2. The food assessment device of claim 1, wherein the turntable plate is placed on a base section providing steadiness to the turntable plate, and wherein the base section comprises a housing for a motor coupled to the turntable plate for rotating the turntable plate in a predefined direction for a predefined time.

3. The food assessment device of claim 2, wherein the base section further comprises a User Interface (UI), wherein the UI further comprises:
a display screen configured for displaying a report associated with the at least one food item;
a set of buttons near the display screen for providing inputs for storing the report of the at least one food item, and syncing display of the report on a user device; and
a power button near the display screen to operate the food assessment device.

4. The food assessment device of claim 3, wherein the report comprises a type of the at least one food item, nutritional content of the at least one food item, an amount of calories within the at least one food item, date and time information of the report generated for the at least one food item.

5. The food assessment device of claim 3, wherein the report is generated based on data collected by scanning of the at least one food item via the at least one AI enabled camera, the set of NIRED sensors, and the at least one LIDAR sensor.

6. The food assessment device of claim 3, wherein the report is generated based on comparison of the data scanned in real-time with historical data stored in a database to determine the nutritional content.

7. The food assessment device of claim 2, further comprises at least one weight sensor between the turntable plate and the housing for collecting weight data of the at least one food item placed on the turntable plate.

8. The food assessment device of claim 2, wherein the housing further comprises a controller configured to control functioning of each of the at least one weight sensor, the at least one Al enabled camera, the set of NIRED sensors, the at least one LIDAR sensor, the motor and the display screen, and for synchronization of the report on the user device, and wherein the controller is coupled to the power button and the set of buttons.

9. The food assessment device of claim 1, further comprising a power cord for power supply connection.

10. The food assessment device of claim 1, wherein a shape of the lid is a dome-shaped structure, and wherein the lid further comprises:
a lightning panel for illuminating a cavity formed by the lid while enclosing the turntable plate, wherein the controller is coupled to the lightning panel; and
a display screen for displaying a scanning percentage of the at least one food item.

11. A method of food assessment using a food assessment device, the method comprising:
receiving, by the food assessment device, a user input for assessing at least one food item placed on a turntable plate of the food assessment device, from a user; wherein the turntable plate is rotational, wherein the turntable is enclosed with a lid, and wherein the lid comprises:
at least one Artificial Intelligence (Al) enabled camera, a set of Near Infrared (NIRED) sensors, and at least one Light Detection and Ranging (LIDAR) sensor facing towards the at least one food item; and
in response to the user input,
starting, by the food assessment device, a rotation of the turntable plate accommodating the at least one food item in a predefined direction, wherein the turntable plate rotates for a predefined time; and
simultaneously scanning, by the food assessment device, the at least one food item until the turntable plate completes the rotation and wherein scanning the at least one food item further comprises:
capturing at least one of video data, or image data of the at least one food item to identify the at least one food item through the at least one AI enabled camera;
determining a chemical composition of the at least one food item by the set of NIRED sensors; and
determining volume of the at least one food item by the at least one LIDAR sensor.

12. The method of claim 11, wherein the turntable plate is placed on a base section providing steadiness to the turntable plate, and wherein the base section comprises a housing for accommodating a motor coupled to the turntable plate and configured for rotating the turntable plate.

13. The method of claim 12, further comprising collecting weight data of the at least one food item via at least one weight sensor, wherein the weight sensor is placed between the turntable plate and the housing.

14. The method of claim 13, further comprises generating a report associated with the at least one food item based on data collected by scanning of the at least one food item via the at least one AI enabled camera, the set of NIRED sensors, and the at least one LIDAR sensor, and the weight data.

15. The method of claim 14, wherein the base section further comprises a User Interface (UI) configured for:
displaying the report associated with the at least one food item through a display screen;
providing inputs for storing the report of the at least one food item through a set of buttons near the display screen, and syncing display of the report on a user device; and
operating the food assessment device via a power button near the display screen.

16. The method of claim 14, wherein the report comprises a type of the at least one food item, the nutritional content of the at least one food item, an amount of calories within the at least one food item, date and time information of the report generated for the at least one food item.

17. The method of claim 14, wherein generating the report further comprises comparing the data scanned in real-time with historical data stored in a database to determine the nutritional content.

18. The method of claim 12, wherein the housing further comprises a controller configured to control functioning of each of the at least one weight sensor, the at least one AI enabled camera, the set of NIRED sensors, the at least one LIDAR sensor, the motor and the display screen, and for synchronization of the report on the user device, and wherein the controller is coupled to the power button and the set of buttons.

19. The method of claim 11, further comprising illuminating a cavity formed by the lid while enclosing the turntable plate via a lightning a panel provided the lid, wherein the controller is coupled to the lightning panel, and wherein a shape of the lid is a dome-shaped structure.

20. The method of claim 11, further comprising displaying a scanned percentage of the at least one food item via a display screen provided on the lid.
